(19) United States
(12) Patent Application Publication
(10) Pub. No.: US 2017/0129984 A1
(43) Pub. Date: May 11, 2017

(54) POLYMER MATERIAL FOR SELF-ASSEMBLY, SELF-ASSEMBLED FILM, AND METHOD FOR PRODUCING SELF-ASSEMBLED FILM

(71) Applicants: NATIONAL UNIVERSITY CORPORATION NAGOYA UNIVERSITY, Aichi-ken (JP); HORIBA STEC, CO., LTD., Kyoto (JP)

(72) Inventors: Atsushi TAKANO, Aichi (JP); Mai TAKAKUWA, Aichi (JP); Kyotarou YAMADA, Aichi (JP); Yushu MATSUSHITA, Aichi (JP); Kazuhiro HIRAHARA, Kyoto (JP); Toshiyuki HIMI, Kyoto (JP); Yukio KAWAGUCHI, Kyoto (JP); Terumasa KOSAKA, Kyoto (JP)

(73) Assignees: NATIONAL UNIVERSITY CORPORATION NAGOYA UNIVERSITY, Aichi-ken (JP); HORIBA STEC, CO., LTD., Kyoto (JP)

(21) Appl. No.: 15/348,299

(22) Filed: Nov. 10, 2016

(30) Foreign Application Priority Data
Nov. 11, 2015 (JP) 2015-221692

(51) Int. Cl. C08F 293/00; C08J 7/04; C08J 5/18

(52) U.S. Cl. CPC C08F 293/005; C08J 5/18; C08J 7/04; C08J 2353/00

(57) ABSTRACT

A polymer material for self-assembly of the present invention includes a multi-block copolymer containing a first polymer block with a structural unit having a specific structure as a main component and a second polymer block with a structural unit having a specific structure as a main component that are coupled with each other.

### CROSS-REFERENCE TO RELATED APPLICATION(S)

The present application claims priority to and incorporates by reference the entire contents of Japanese Patent Application No. 2015-221692 filed in Japan on Nov. 11, 2015.

### BACKGROUND OF THE INVENTION

1. Field of the Invention

The present invention relates to a polymer material for self-assembly, a self-assembled film, and a method for producing a self-assembled film and, specifically, to a polymer material for self-assembly, a self-assembled film, and a method for producing a self-assembled film used suitably for resists for producing semiconductors or the like.

2. Description of the Related Art

In recent years, a fine pattern formation technique using the directed self-assembly (DSA) technique of block copolymers has been gaining the spotlight (refer to Japanese Patent Application Laid-open No. 2005-7244, Japanese Patent Application Laid-open No. 2005-8701, Japanese Patent Application Laid-open No. 2005-8882, Japanese Patent Application Laid-open No. 2003-218383, Japanese Patent Application Laid-open No. 2010-269304, Japanese Patent Application Laid-open No. 2011-129874, and Japanese Patent Application Laid-open No. 2012-108369, for example). This directed self-assembly technique can produce guide patterns further reduced by several levels compared with guide patterns produced using conventional photolithography techniques (the ArF immersion method, for example). The directed self-assembly technique can form patterns finer than those by electron beam (EB) and extreme ultraviolet (EUV), which are said to be the ultimate fine processing techniques.

In the fields of photonics crystals, a method for controlling the domain size of organic thin film solar cells, drag delivery polymer micelles, biomaterials, and the like, the formation of patterns such as a fine line/space (hereinafter, also referred to as an “L/S”) and a minute hole (hereinafter, also referred to as a “CH”) of 10 nm or less is desired. However, the conventional techniques such as photolithography, electron beam, and extreme ultraviolet are insufficient in the capability of forming microscopic phase separation, produce defects caused by faulty phase structure formation, and have difficulty in the formation of patterns of 10 nm or less.

### SUMMARY OF THE INVENTION

It is an object of the present invention to at least partially solve the problems in the conventional technology.

A polymer material for self-assembly comprising a multi-block copolymer containing a first polymer block with a structural unit represented by the following General Formula (1) as a main component and a second polymer block with a structural unit represented by the following General Formula (2) as a main component that are coupled with each other:

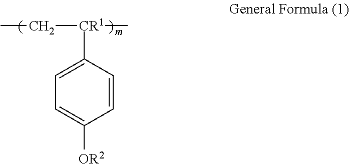

(in General Formula (1), R¹ indicates a hydrogen atom or a C₁₋₃ alkyl group, R² indicates a hydrogen atom or a C₁₋₅ alkyl group, and m is an integer of 1 or more and 1,000 or less); and

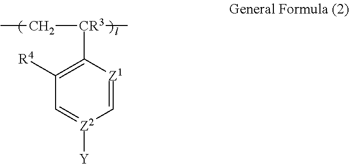

(in General Formula (2), Z¹ and Z² each represent a carbon atom or a nitrogen atom, in which when either Z¹ or Z² is a nitrogen atom, the other is a carbon atom; Y is absent when Z² is a nitrogen atom, and represents a hydrogen atom or OR⁵ when Z² is a carbon atom; R³ represents a hydrogen atom or a C₁₋₃ alkyl group; R⁴ represents a hydrogen atom, a vinyl group, or a C₂₋₅ vinylidene group; R⁵ represents a C₁₋₁₀ alkyl group; and l is an integer of 1 or more and 1,000 or less).

A self-assembled film comprising the polymer material for self-assembly.

A method for producing a self-assembled film, the method comprising forming a self-assembled film using the polymer material for self-assembly.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a microdomain structure of a polymer material containing two polymer components;

FIG. 2A is a diagram of a microdomain structure of a spherical structure;

FIG. 2B is a diagram of a microdomain structure of a cylinder structure;

FIG. 2C is a diagram of a microdomain structure of a gyroid structure;

FIG. 2D is a diagram of a microdomain structure of a lamellar structure;

FIG. 3 is a schematic diagram of a molecular chain of a block copolymer;

FIG. 4 is a diagram of examples of multi-block copolymers;

FIG. 5A is a schematic diagram of a lamellar structure as an example of a microscopic phase separation structure that the multi-block copolymer forms;

FIG. 5B is a schematic diagram of a lamellar structure as an example of the microscopic phase separation structure that the multi-block copolymer forms;

FIG. 5C is a schematic diagram of a lamellar structure as an example of the microscopic phase separation structure that the multi-block copolymer forms;

FIG. 5D is a schematic diagram of a lamellar structure as an example of the microscopic phase separation structure that the multi-block copolymer forms;

FIG. 6A is a schematic diagram of a lamellar structure as an example of the microscopic phase separation structure that the multi-block copolymer forms;

FIG. 6B is a schematic diagram of a lamellar structure as an example of the microscopic phase separation structure that the multi-block copolymer forms;

FIG. 6C is a schematic diagram of a lamellar structure as an example of the microscopic phase separation structure that the multi-block copolymer forms;

FIG. 6D is a schematic diagram of a lamellar structure as an example of the microscopic phase separation structure that the multi-block copolymer forms;

FIG. 7 is a diagram of a GPC chart of Tetrablock Copolymer (1-1);

FIG. 8 is a diagram of a ¹H-NMR measurement result of Tetrablock Copolymer (1-1);

FIG. 9 is a diagram of ¹H-NMR measurement results of Tetrablock Copolymer (1-1) and Tetrablock Copolymer (1-2);

FIG. 10 is a transmission electron microscopic (TEM) image of a section; and

FIG. 11 is a diagram of a SAXS observation result of a pattern obtained using Triblock Copolymer (2).

### DETAILED DESCRIPTION OF THE PREFERRED EMBODIMENTS

The directed self-assembly (hereinafter, also referred to as “DSA”) technique in semiconductors is a technique using the capability of forming microscopic phase separation appearing when two kinds of polymer chains that are incompatible with each other are coupled with each other at one point through copolymerization. In multi-block copolymers such as a diblock copolymer coupled through a covalent bond, when the same polymer component assembles in an inter-molecular manner to cause microscopic phase separation, an interface curvature at the time of molecular assembly changes in accordance with the volume fraction ratio (f) between two polymer components, and a microdomain structure changes.

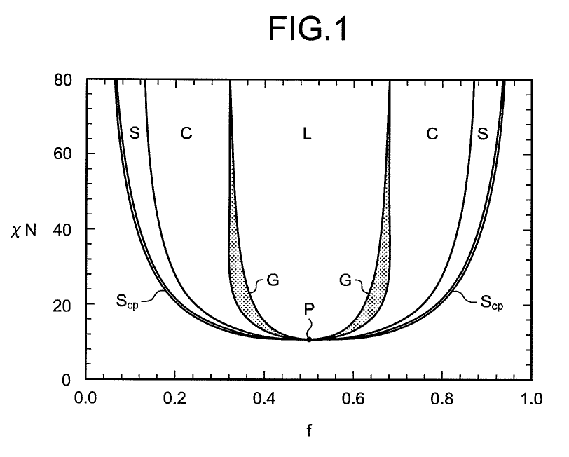

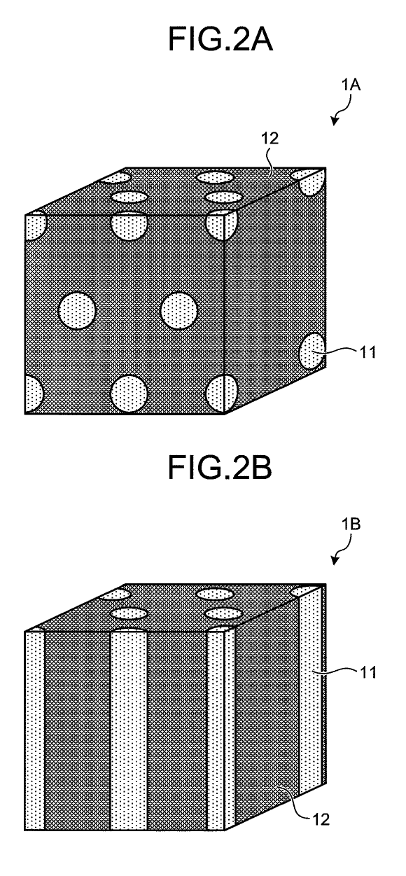

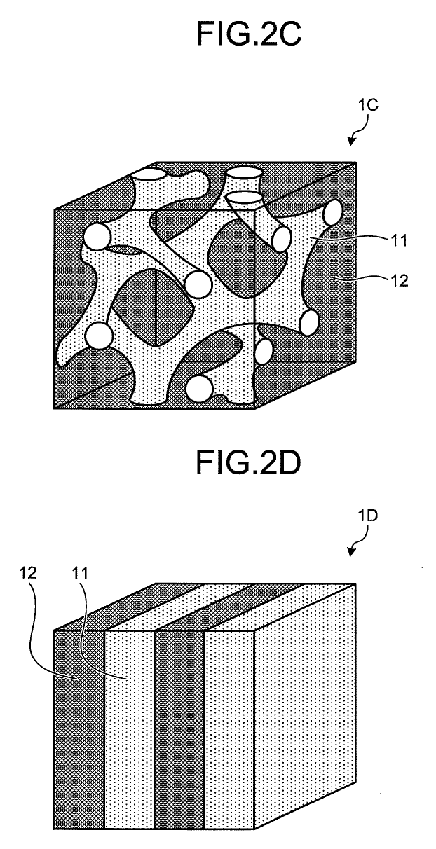

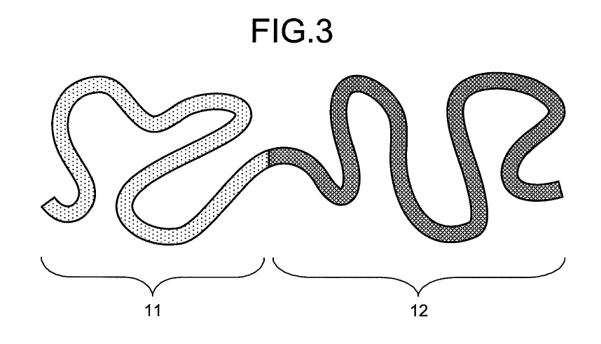

FIG. 1 is a diagram of a microdomain structure of a polymer material containing two polymer components, FIG. 2A is a diagram of a microdomain structure of a spherical structure, FIG. 2B is a diagram of a microdomain structure of a cylinder structure, FIG. 2C is a diagram of a microdomain structure of a gyroid structure, and FIG. 2D is a diagram of a microdomain structure of a lamellar structure. FIG. 3 is a schematic diagram of a molecular chain of a block copolymer. In FIG. 1, the vertical axis indicates a product χN of an interaction parameter χ and a degree of polymerization N of a polymer, whereas the horizontal axis indicates a composition (f) between a first component and a second component.

As illustrated in FIG. 1, the microscopic domain structure of the polymer material containing the two polymer components gives orderly morphology including a spherical structure 1A (refer to FIG. 2A) in an area S in FIG. 1, a cylinder structure 1B (refer to FIG. 2B) in an area C in FIG. 1, a gyroid structure 1C (refer to FIG. 2C) in an area G in FIG. 1, and a lamellar structure 1D (refer to FIG. 2D) in an area L in FIG. 1 in accordance with a compositional change. A point P in FIG. 1 gives an amorphous state. In order to obtain a smaller microscopic phase separation structure using the polymer material, the molecular weights of a first polymer block 11 and a second polymer block 12 of the block copolymer illustrated in FIG. 3 may be reduced while maintaining the composition thereof. However, it is shown that only reducing the molecular weights of the first polymer block 11 and the second polymer block 12 reaches a region in which phase separation does not occur after all.

The following Table 1 lists a relation between the molecular weight and the properties including the boiling point, the melting point, and the appearance of polyethylene as an example of the polymer material. As listed in Table 1, polyethylene decreases in molecular weight and boiling point along with a decrease in the degree of polymerization (n). Polyethylene becomes a waxy and fragile solid in an oligomer range with a molecular weight of 3,000 or less and does not satisfy basic polymer properties such as having a sturdy solid, a high glass transition temperature, and the capability of forming a tough film. For this reason, it is shown that when the molecular weight of the block copolymer is reduced in order to obtain a fine microscopic phase separation structure, the polymer material reaches the region in which phase separation does not occur after all, becomes a region of molecular weight of oligomer or oligomer or less, loses properties as the polymer material, and cannot obtain properties as a polymer.

TABLE 1

| Degree of | | Melting | Boiling | |
|---|---|---|---|---|
| polymeri- | Molecular | point | point | |
| zation (n) | weight | (° C.) | (° C.) | Appearance |
| 1 | 30 | −183 | −88.6 | Gas |
| 10 | 282 | −30 | 174 | Liquid |
| 20 | 562 | 38 | >300 | Waxy |
| 60 | 1,682 | 100 | Decomposed | Waxy solid |
| 100 | 2,802 | 106 | Decomposed | Fragile |
| | | | | solid |
| 1,000 | 28,002 | 110 | Decomposed | Sturdy |
| | | | | solid |

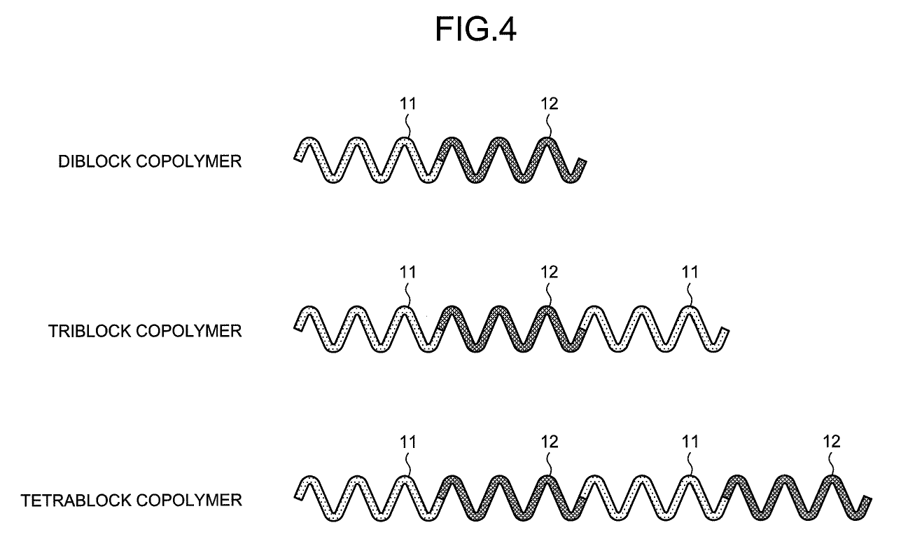

In order to obtain a smaller microscopic phase separation structure while maintaining the properties of the polymer material, a multi-block copolymer in which the two polymer blocks, or the first polymer block 11 and the second polymer block 12, forming the diblock copolymer are repeatedly introduced can be used. FIG. 4 is a diagram of an example of the multi-block copolymer. As illustrated in FIG. 4, the multi-block copolymer includes the diblock copolymer containing the first polymer block 11 and the second polymer block 12 that are coupled with each other, a triblock copolymer containing the first polymer block 11, the second polymer block 12, and the first polymer block 11 that are coupled with each other, and a tetrablock copolymer containing the first polymer block 11, the second polymer block 12, the first polymer block 11, and the second polymer block 12 that are coupled with each other. The triblock copolymer may be a triblock copolymer containing the first polymer block 11, the second polymer block 12, and a third polymer block other than the first polymer block 11 and the second polymer block 12 that are coupled with each other in addition to the example illustrated in FIG. 4. By thus forming the multi-block copolymer, even when the chain length of the molecular chain of the polymer blocks forming the multi-block copolymer is short, the sequence of the first polymer block 11 and the second polymer block 12 is repeated, whereby the sum total of the molecular weight can be increased, and the polymer properties can be imparted.

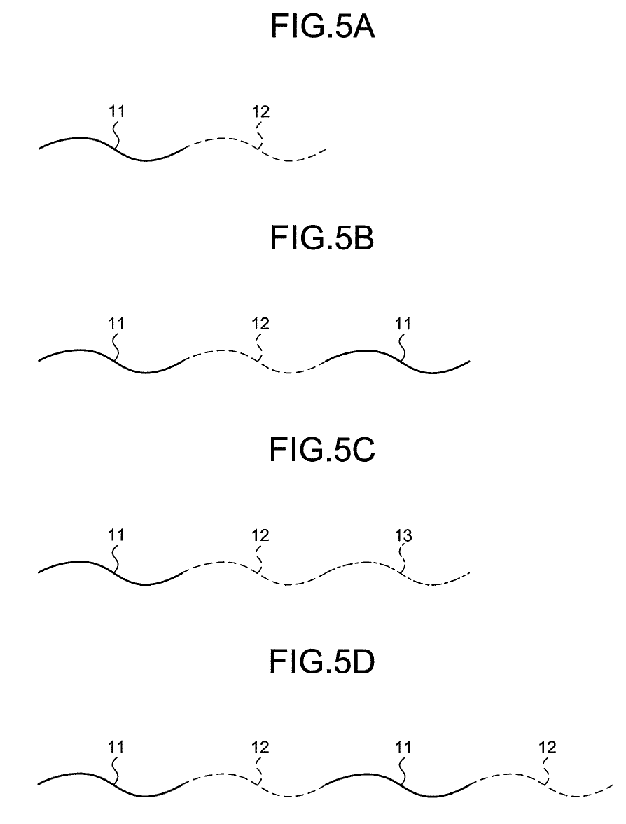

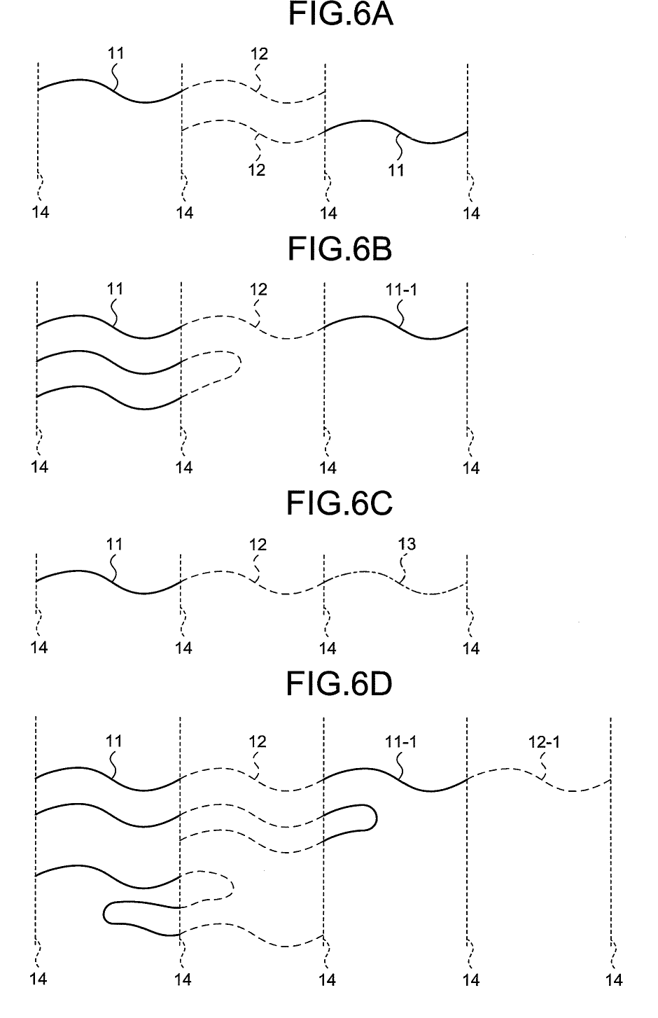

FIG. 5A to FIG. 5D and FIG. 6A to FIG. 6D are schematic diagrams of lamellar structures as an example of the microscopic phase separation structure that the multi-block copolymer forms. As illustrated in FIG. 5A and FIG. 6A, the structure that a block chain formed of the first polymer block 11 and the second polymer block 12 that are coupled with each other of the diblock copolymer can take in domains is one type that is a structure that passes through an interface 14 of the domains of the first polymer block 11 and the second polymer block 12. As illustrated in FIG. 5B and FIG. 6B, the structure that a block chain formed of the first polymer block 11, the second polymer block 12, and the first polymer block 11 that are coupled with each other of the triblock copolymer can take in domains includes two types including a structure that passes through the interfaces 14 of the domains of the first polymer block 11, the second polymer block 12, and a first polymer block 11-1 and a structure that passes through the interface 14 of the first polymer block 11, folds back within the second polymer block 12, and passes through the domain of the first polymer block 11. As illustrated in FIG. 5C and FIG. 6C, the structure that a block chain formed of the first polymer block 11, the second polymer block 12, and a third polymer block 13 that are coupled with each other of the triblock copolymer can take in domains is one type that is a structure that passes through the interfaces 14 of the first polymer block 11, the second polymer block 12, and the third polymer block 13.

As illustrated in FIG. 5D and FIG. 6D, the structure that a block chain formed of the first polymer block 11, the second polymer block 12, the first polymer block 11-1, and a second polymer block 12-1 that are coupled with each other of the tetrablock copolymer can take in domains includes three types including a structure that passes through the interfaces 14 of the first polymer block 11, the second polymer block 12, the first polymer block 11-1, and the second polymer block 12-1, a structure that passes through the interfaces 14 of the first polymer block 11 and the second polymer block 12, folds back within the first polymer block 11-1, and reaches the domain of the second polymer block 12, and a structure that passes through the interface 14 of the first polymer block 11, folds back within the second polymer block 12, again folds back within the first polymer block 11-1, and reaches the domain of the second polymer block 12. It is known that the mechanical strength of the block copolymers is higher in a structure in which the polymer chain generally passes through many domains as illustrated in the upper row FIG. 6B and of FIG. 6D (Literature: Macromolecules, Vol. 16, No. 1, 1983). A loop structure illustrated in the lower row of FIG. 6B and FIG. 6D is preferably less. The multi-block copolymer such as the triblock copolymer illustrated in the upper row of FIG. 6B, in which the block chain has many forms that can be taken, shows strength higher than that of the diblock copolymer.

When a diblock copolymer having a lower molecular weight is assumed, the entanglement of the molecular chain of the second polymer block 12 is less in the domain of the second polymer block 12, and when a force is applied in the lateral direction, the lamellar structure breaks relatively easily. In contrast, the triblock copolymer and the tetrablock copolymer have the structure that passes through the domains of the first polymer block 11, the second polymer block 12, and the first polymer block 11 or the domains of the first polymer block 11, the second polymer block 12, the first polymer block 11, and the second polymer block 12, and a stronger flocculation force acts. Under these circumstances, the triblock copolymer and the tetrablock copolymer can form a smaller microscopic phase separation structure than the diblock copolymer and can thereby impart more excellent polymer properties.

In the DSA technique, fine processing that is difficult by the conventional photolithography technique, electron beam lithography (EB), and extreme ultraviolet lithography (EUV) is studied. However, a styrene-methyl methacrylate-based diblock copolymer used in the conventional DSA technique does not form any microscopic phase separation structure from around 14 nm and has difficulty in forming a line/space and a hole of 10 nm or less. Although diblock copolymers formed of block chains other than styrene-methyl methacrylate are studied, most lose the capability of forming microscopic phase separation in the region of around 10 nm or less and may fail to obtain a desired phase structure or produce defects caused by faulty phase structure formation.

The inventors of the present invention paid attention to the characteristics of the polymer material and, as a result of earnest study to solve the problems, paid attention to the capability of solving the problems by changing the diblock copolymer into a multi-block copolymer without changing the chain lengths of the respective block chains of the diblock copolymer. In other words, the inventors of the present invention have found out that using the diblock copolymer having the first polymer block 11 and the second polymer block 12 can maintain the polymer properties while holding a fine microscopic phase separation structure. Further, the inventors of the present invention have found out that using an ABA type (or an ABC type) triblock copolymer having an increased entire molecular weight by adding the first polymer block 11 (or the third polymer block 13) as a new third component to the diblock copolymer or an ABAB type (or an ABCA type or the like) tetrablock copolymer obtained by further adding the third polymer block and a fourth polymer block can maintain the polymer properties while holding a finer microscopic phase separation structure. The inventors of the present invention have found out that the multi-block copolymers such as the diblock copolymer, the triblock copolymer, and the tetrablock copolymer can easily form the L/S and the CH of 10 nm or less and can form a fine, minute repeated pattern with reduced defects based on faulty microscopic phase separation sites to complete the present invention.

The following describes an embodiment of the present invention in detail.

The polymer material for self-assembly according to the present invention contains a multi-block copolymer containing a first polymer block with a structural unit represented by the following General Formula (1) as a main component and a second polymer block with a structural unit represented by the following General Formula (2) as a main component that are coupled with each other through copolymerization:

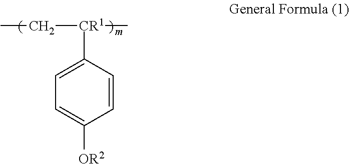

(in General Formula (1), R¹ indicates a hydrogen atom or a C₁₋₃ alkyl group, R² indicates a hydrogen atom or a C₁₋₅ alkyl group, and m is an integer of 1 or more and 1,000 or less); and

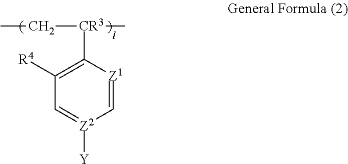

(in General Formula (2), Z¹ and Z² each represent a carbon atom or a nitrogen atom, in which when either Z¹ or Z² is a nitrogen atom, the other is a carbon atom; Y is absent when Z² is a nitrogen atom, and represents a hydrogen atom or OR⁵ when Z² is a carbon atom; R³ represents a hydrogen atom or a C₁₋₃ alkyl group; R⁴ represents a hydrogen atom, a vinyl group, or a C₂₋₅ vinylidene group; R⁵ represents a C₁₋₁₀ alkyl group; and 1 is an integer of 1 or more and 1,000 or less).

This polymer material for self-assembly repeats the first polymer block with the structural unit represented by General Formula (1) as the main component and the second polymer block with the structural unit represented by General Formula (2) as the main component and having polarity different from that of the first polymer block and thereby facilitates a mutual repulsive force, and microscopic phase separability increases, whereby defects based on faulty microscopic phase separation can be reduced, and a finer repeated pattern can be formed. Consequently, a polymer material for self-assembly that can reduce the defects based on the faulty microscopic phase separation sites and can besides form the fine, minute repeated pattern can be achieved.

R¹ in General Formula (1) is not limited to a particular group so long as it is a hydrogen atom or a C₁₋₃ alkyl group. Examples of the C₁₋₃ alkyl group include a methyl group, an ethyl group, an n-propyl group, and an iso-propyl group. Among these, R¹ is preferably a hydrogen atom or a methyl group and more preferably a hydrogen atom in view of being capable of reducing the defects based on the faulty microscopic phase separation sites and besides capable of forming the fine, minute repeated pattern.

R² in General Formula (1) is not limited to a particular group so long as it is a hydrogen atom or a C₁₋₅ alkyl group. Examples of the C₁₋₅ alkyl group include a methyl group, an ethyl group, an n-propyl group, an iso-propyl group, an n-butyl group, an s-butyl group, a t-butyl group, an n-pentyl group, and a neopentyl group. Among these, R² is preferably a hydrogen atom, a methyl group, an ethyl group, an n-propyl group, an iso-propyl group, an n-butyl group, an s-butyl group, or a t-butyl group, more preferably a hydrogen atom or a methyl group, and further preferably a hydrogen atom in view of being capable of reducing the defects based on the faulty microscopic phase separation sites and besides capable of forming the fine, minute repeated pattern.

Z¹ and Z² in General Formula (2) each represent a carbon atom or a nitrogen atom, in which when either Z¹ or Z² is a nitrogen atom, the other is a carbon atom. In this case, concerning Z¹ and Z², Z¹ is preferably a nitrogen atom, whereas Z² is preferably a carbon atom in view of being capable of reducing the defects based on the faulty microscopic phase separation sites and besides capable of forming the fine, minute repeated pattern.

R³ in General Formula (2) is not limited to a particular group so long as it is a hydrogen atom or a C₁₋₃ alkyl group. Examples of the C₁₋₃ alkyl group include a methyl group, an ethyl group, an n-propyl group, and an iso-propyl group. Among these, R³ is preferably a hydrogen atom or a methyl group and more preferably a hydrogen atom in view of being capable of reducing the defects based on the faulty microscopic phase separation sites and besides capable of forming the fine, minute repeated pattern.

R⁴ in General Formula (2) is not limited to a particular group so long as it is a vinyl group or a C₂₋₅ vinylidene group. Examples of the C₂₋₅ vinylidene group include a vinylene group, a vinylidene group, a propylidene group, a butylidene group, and a pentylidene group. Among these, R⁴ is preferably a vinyl group, a vinylene group, or propylidene group and more preferably a vinyl group in view of being capable of reducing the defects based on the faulty microscopic phase separation sites and besides capable of forming the fine, minute repeated pattern.

Y in General Formula (2) is absent when Z² is a nitrogen atom, and represents a hydrogen atom or OR⁵ when Z² is a carbon atom. R⁵ in General Formula (2) is not limited to a particular group so long as it is a C₁₋₁₀ alkyl group. R⁵ is preferably a C₁₋₇ alkyl group and more preferably a C₁₋₅ alkyl group in view of being capable of reducing the defects based on the faulty microscopic phase separation sites and besides capable of forming the fine, minute repeated pattern. Examples of R⁵ include alkyl groups such as a methyl group, an ethyl group, an n-propyl group, an iso-propyl group, an n-butyl group, an s-butyl group, a t-butyl group, an n-pentyl group, a neopentyl group, a hexyl group, a heptyl group, an octyl group, a nonyl group, and a decyl group. Among these, R⁵ is preferably a methyl group, an ethyl group, an n-propyl group, an iso-propyl group, an n-butyl group, an s-butyl group, a t-butyl group, an n-pentyl group, a neopentyl group, a hexyl group, or a heptyl group and more preferably a methyl group, an ethyl group, an n-propyl group, an iso-propyl group, an n-butyl group, an s-butyl group, a t-butyl group, an n-pentyl group, or a neopentyl group in view of being capable of reducing the defects based on the faulty microscopic phase separation sites and besides capable of forming the fine, minute repeated pattern.

For the first polymer block of the multi-block copolymer, a first polymer block A obtained by repeatedly polymerizing the same structural unit represented by General Formula (1) or a first polymer block B obtained by repeatedly polymerizing the structural unit represented by General Formula (1) and a structural unit different from General Formula (1) can be used. For the second polymer block of the multi-block copolymer, a second polymer block C obtained by repeatedly polymerizing the same structural unit represented by General Formula (2) or a second polymer block D obtained by repeatedly polymerizing the structural unit represented by General Formula (2) and a structural unit different from General Formula (2) can be used. For the triblock copolymer, one in which the polymer blocks A-D are unlimitedly arranged such as ACA, ACB, ADA, or ADB can be used. Among these, the triblock copolymer preferably has an arrangement of ACA or ADA in view of being further capable of reducing the defects based on the faulty microscopic phase separation sites and besides capable of forming the fine, minute repeated pattern. For the tetrablock copolymer, any arrangement such as ACAC, ACBC, ADAD, or ADBC can be used. Among these, the tetrablock copolymer is preferably ACAC or ADAD in view of being capable of reducing the defects based on the faulty microscopic phase separation sites and besides capable of forming the fine, minute repeated pattern.

For the multi-block copolymer, a triblock copolymer containing the first polymer block with the structural unit represented by General Formula (1) as a main component and the second polymer block with the structural unit represented by General Formula (2) as a main component may be used, or a tetrablock copolymer may be used. For the multi-block copolymer, a multi-block copolymer of a pentablock copolymer or more formed of a plurality of first polymer blocks and second polymer blocks that are coupled with each other through copolymerization can be used. Among these, the multi-block copolymer is preferably the triblock copolymer or the tetrablock copolymer in view of being capable of reducing the defects based on the faulty microscopic phase separation sites and besides capable of forming the fine, minute repeated pattern. The ratio of the structural units when the triblock copolymer and the tetrablock copolymer are used as polymer compounds is not limited to a particular ratio, and the ratio can be selected as appropriate in accordance with the type of the microdomain structure formed by self-assembly.

The ratio of the structural units of the multi-block copolymer is, in terms of a composition ratio (m:l) between a structural unit (m) represented by General Formula (1) and a structural unit (l) represented by General Formula (2), preferably in the range of m:l=8:2 to 2:8 in view of improving the pattern uniformity and regularity of the microdomain structure formed by self-assembly. When the lamellar structure is formed by self-assembly, for example, the ratio (m:l) between the structural unit (m) represented by General Formula (1) and the structural unit (l) represented by General Formula (2) is preferably in the range of m:l=4:6 to 6:4 and more preferably m:l=5:5 in view of improving the pattern uniformity and regularity of the microdomain structure formed by self-assembly. When the cylinder structure is formed by self-assembly, the ratio (m:l) between the structural unit (m) represented by General Formula (1) and the structural unit (l) represented by General Formula (2) is preferably in the range of m:l=3:7 to 7:3 in view of improving the pattern uniformity and regularity of the microdomain structure formed by self-assembly. In this case, a structural unit of the smaller ratio forms the internal film of the cylinder structure.

The average number of molecules of each of the first polymer block and the second polymer block is preferably 10 or more and 1,000 or less, more preferably 15 or more and 100 or less, further preferably 20 or more and 50 or less, and still further preferably 25 or more and 40 or less in view of improving the pattern uniformity and regularity of the microdomain structure formed by self-assembly.

The average number of molecules of the second polymer block is preferably 10 or more and 1,000 or less, more preferably 30 or more and 500 or less, further preferably 50 or more and 200 or less, and still further preferably 70 or more and 100 or less in view of improving the pattern uniformity and regularity of the microdomain structure formed by self-assembly.

The number average molecular weight (Mn) of the multi-block copolymer is preferably 3,000 or more, more preferably 5,000 or more, and further preferably 6,000 or more and preferably 100,000 or less, more preferably 50,000 or less, and further preferably 20,000 or less in view of improving the pattern uniformity and regularity of the microdomain structure formed by self-assembly. When the number average molecular weight (Mn) is 3,000 or more, self-assembly proceeds, and a self-assembled film in which the microscopic domain structure is formed is obtained. When the number average molecular weight (Mn) is 50,000 or less, hydrogen bonding of hydrophilic groups of the polymer compound moderately acts, self-assembly occurs without the shortage of a χ parameter among the block copolymers, and the microdomain structure is formed, whereby the pattern size can be easily 10 nm or less. The polymer material for self-assembly according to the present invention contains the multi-block copolymer with a number average molecular weight (Mn) of 10,000 or less within the range that produces the advantageous effects of the present invention.

The polydispersity index (PDI: Mw/Mn=PDI) of the multi-block copolymer is preferably 1.0 or more and more preferably 1.02 or more and preferably 1.1 or less and more preferably 1.06 or less in view of being capable of reducing the defects based on the faulty microscopic phase separation sites and besides capable of forming the fine, minute repeated pattern. When the PDI is 1.0 or more and 1.1 or less, the mixing of a low molecular weight polymer and a high molecular weight polymer hardly occurs, and the pattern uniformity and regularity of the microdomain structure formed by self-assembly improve.

The number average molecular weight (Mn) and the PDI are measured by the gel permeation chromatography (GPC) in terms of polystyrene as a standard substance. The weight−average molecular weight by the GPC is calculated using a GPC measuring apparatus (product name: HLC-8220GPC manufactured by Tosoh Corporation), a column (product name: GPC Column TSKgel Super HZ2000 HZ3000 manufactured by Tosoh Corporation), and a mobile phase (THF) by measuring at a column temperature of 30° C., using the calibration curve of the standard polystyrene, for example.

The composition ratio of the multi-block copolymer can be determined by the nuclear magnetic resonance (NMR). The composition ratio by the NMR can be measured under the condition of an NMR measuring apparatus (product name: Bruker TopSpin 3.2, 500 MHz) a temperature of 25° C., a solvent (CDCl₃), internal standard: tetramethylsilane (TMS), And an integrated number of times of 128, for example.

The multi-block copolymer is preferably a multi-block copolymer of the first polymer block with the structural unit represented by General Formula (1) as the main component and the second polymer block with the structural unit represented by General Formula (2) as the main component that are copolymerized by living anionic polymerization. A polymer compound is copolymerized by living anionic polymerization, whereby the PDI can be extremely narrowed, and a polymer compound having a desired weight−average molecular weight can be obtained with high precision. With this copolymerization, the pattern uniformity and regularity of the microdomain structure formed by self-assembly can be improved.

A method for producing the polymer compound, which is the multi-block copolymer, is not limited to a particular method so long as it can copolymerize the first polymer block with the structural unit represented by General Formula (1) as the main component and the second polymer block with the structural unit represented by General Formula (2) as the main component. Examples of the method of polymerization to obtain the polymer compound include living anionic polymerization, living cationic polymerization, living radical polymerization, and coordinated polymerization using an organometallic catalyst. Among these, living anionic polymerization is preferable, which enables living polymerization with less deactivation of polymerization and side reactions.

In living anionic polymerization, a monomer for polymerization subjected to deoxidation and dehydration treatment and an organic solvent are used. Examples of the organic solvent include hexane, cyclohexane, toluene, benzene, diethyl ether, and tetrahydrofuran. In living anionic polymerization, an anionic species is added to any of these organic solvents in a necessary amount, and a monomer is then added thereto as needed, thereby performing polymerization. Examples of the anionic species include organic metals such as alkyl lithium, alkyl magnesium halide, sodium naphthalene, and alkylated lanthanoid compounds. In the present invention, substituted polystyrene is copolymerized as the monomer, and the anionic species is preferably s-butyl lithium or butyl magnesium chloride among these. The polymerization temperature of living anionic polymerization is preferably within the range of −100° C. or higher and 50° C. or lower and more preferably −70° C. or higher and 40° C. or lower in view of facilitating the control of polymerization.

A method for producing the multi-block copolymer performs block copolymerization on a monomer of substituted styrene with a protected phenolic hydroxy group such as p-(1-ethoxyethyl)styrene or 4-t-butoxy styrene by living anionic polymerization on the above conditions to synthesize the block copolymer, for example. This block copolymer can deprotect the phenolic hydroxy group of the obtained polymer compound using an acid catalyst such as oxalic acid. Examples of a protecting group for the phenolic hydroxy group during polymerization include a t-butyl group and a trialkylcyril group. When another monomer having an ether moiety or an ester moiety is copolymerized in the polymer compound, selective deprotection is performed by the adjustment of the acidity during the deprotection reaction and a deprotection reaction under alkaline conditions, whereby the phenolic hydroxy group can be obtained.

The self-assembled film according to the present invention can be obtained by dissolving the polymer material for self-assembly in an organic solvent and applying it. The organic solvent dissolving the polymer material for self-assembly is not limited to a particular organic solvent so long as it can obtain the self-assembled film; examples thereof include butyl acetate, amyl acetate, cyclohexyl acetate, 3-methoxybutyl acetate, methyl ethyl ketone, methyl amyl ketone, cyclohexanone, cyclopentanone, 3-ethoxyethyl propionate, 3-ethoxymethyl propionate, 3-methoxymethyl propionate, methyl acetoacetate, ethyl acetoacetate, diacetone alcohol, methyl pyruvate, ethyl pyruvate, propylene glycol monomethyl ether, propylene glycol monoethyl ether, propylene glycol monomethyl ether propionate, propylene glycol monoethyl ether propionate, ethylene glycol monomethyl ether, ethylene glycol monoethyl ether, diethylene glycol monomethyl ether, diethylene glycol monoethyl ether, 3-methyl-3-methoxy butanol, N-methyl pyrrolidone, dimethylsulfoxide, γ-butyrolactone, propylene glycol methyl ether acetate, propylene glycol ethyl ether acetate, propylene glycol propyl ether acetate, methyl lactate, ethyl lactate, propyl lactate, and tetramethylene sulfone. These solvents may be used singly, or two or more of them may be used in combination.

The organic solvent dissolving the polymer material for self-assembly is preferably a propylene glycol alkylether acetate or an alkyl lactate. Examples of the propylene glycol alkylether acetate include one having a C₁₋₄ alkyl group. Examples of the alkyl group include a methyl group, an ethyl group, a propyl group, and a butyl group. Among these, a methyl group and an ethyl group are preferable. The propylene glycol alkylether acetate includes three isomers depending on the combination of substitution positions including a 1,2-substitution product and a 1,3-substitution product; these isomers may be used singly, or two or more of the isomers may be used in combination.

Examples of the alkyl lactate include one having a C₁₋₄ alkyl group. Examples of the alkyl group include a methyl group, an ethyl group, a propyl group, and a butyl group. Among these, a methyl group and an ethyl group are preferable.

Concerning the concentration of the organic solvent, when the propylene glycol alkylether acetate is used, for example, the propylene glycol alkylether acetate is preferably 50% by mass or more relative to the entire mass of the organic solvent. When the alkyl lactate is used, it is preferably 50% by mass or more relative to the entire mass of the organic solvent. When a mixed solvent of the propylene glycol alkylether acetate and the alkyl lactate is used as the organic solvent, the total amount of the mixed solvent is preferably 50% by mass or more relative to the entire mass of the organic solvent. When this mixed solvent is used, the ratio is preferably as follows: the propylene glycol alkylether acetate is 60% by mass or more and 95% by mass or less, whereas the alkyl lactate is 5% by mass or more and 40% by mass or less. When the propylene glycol alkylether acetate is 60% by mass or more, the applicability of the polymer material for self-assembly is favorable. When the propylene glycol alkylether acetate is 95% by mass or less, the solubility of the polymer material for self-assembly improves.

The solution of the organic solvent of the polymer material for self-assembly is not limited to a particular concentration so long as it can obtain the self-assembled film by a conventionally known method; the organic solvent is preferably 5,000 parts by mass or more and 50,000 parts by mass or less and more preferably 7,000 parts by mass or more and 30,000 parts by mass or less relative to 100 parts by mass of the solid content of the polymer material for self-assembly, for example.

A method for applying the polymer material for self-assembly is not limited to a particular method so long as it can obtain the self-assembled film; examples thereof include spin coating, immersion, flexographic printing, inkjet printing, spraying, potting, and screen printing.

A top coating agent may be applied onto the self-assembled film. With this application, the self-assembled film is sealed and protected, and the self-assembled film improves in handleability and weatherability. Examples of the top coating agent include polyester-based top coating agents, polyamide-based top coating agents, polyurethane-based top coating agents, epoxy-based top coating agents, phenol-based top coating agents, (meth)acrylic-based top coating agents, polyvinyl acetate-based top coating agents, polyolefin-based top coating agents such as polyethylene and polypropylene, and cellulose-based top coating agents. The coating amount (in terms of solid content) of the top coating agent is preferably 3 g/m² or more and 7 g/m² or less. The top coating agent can be applied onto the self-assembled film by a conventionally known method of application.

The self-assembled film may be formed within a guide pattern. In this case, the self-assembled film can be formed by applying a solution of a polymer material for a self-assembled film onto a guide pattern-equipped silicon substrate or the like, for example. Annealing treatment at 200° C. or higher and 300° C. or lower for 5 minutes or more and 1 hour or less gives a pattern of a self-assembled microscopic domain structure on the silicon substrate. The obtained pattern of the microscopic domain structure is etched with an oxygen plasma gas, whereby an L/S pattern with a half pitch (hp) of 10 nm or less and a CH pattern with an hp of 5 nm or less can be obtained.

For the multi-block copolymer, a flocculation force can be evaluated by transmission electron microscopic (TEM) observation and small-angle X-ray scattering (SAXS) measurement. An evaluation sample of the flocculation force can be prepared by preparing a sample film of 50 mg of the multi-block copolymer, dissolving the prepared sample in 1 g of additive-free THF and moving the sample to a Teflon petri dish, and casting the sample in the Teflon petri dish for 10 days and drying the sample in a vacuum, for example.

In the TEM observation, the sample film is first cut into appropriate sizes and is put in an embedding mold, and an epoxy resin is then poured thereinto, which is left at rest at 60° C. for 12 hours to cure the epoxy resin, whereby embedding treatment is performed. The sample film subjected to the embedding treatment is cut into a section with a thickness of about 50 nm using a microtome. The section is then gathered on a Cu grid, is dyed with Cs₂CO₃, and is then observed with a transmission electron microscope (product name: JEOL JEM-1400, acceleration voltage 120 kV), whereby the hp can be measured.

In the SAXS measurement, the hp can be measured by cutting the sample film into 5 mm×2 mm with a razor and irradiating the sample film with X-rays from an edge direction by a SAXS measuring apparatus (product name: Photon Factory Beam Line 6A, camera length: 2.5 m, wavelength: λ=0.15 nm, detector: PILATUS). In the SAXS measurement using a synchrotron radiation beam, microscopic phase separability measurement in a bulk state is performed for the sample film using a small-angle X-ray scattering (SAXS) analyzer of a synchrotron radiation beam line (product name: BL45XU, Spring-8, super photon ring-8GeV manufactured by High Energy Accelerator Research Organization). X-rays are made incident on the sample film of the multi-block copolymer, and the angle dependence of scattering appearing on the smaller angle side is measured by an imaging plate for 30 minutes. In measured data processing, background correction such as air scattering is performed to calculate q/nm-1, Fourier transformation analysis is performed, and the value of half pitch (hp) of the self-assembled film, which is half the average repeated pattern size width (=D) of the microscopic domain structure by the self-assembly of the block copolymer is measured.

As described above, according to the polymer material for self-assembly according to the present invention, both the first polymer block with the structural unit represented by General Formula (1) as the main component and the second polymer block with the structural unit represented by General Formula (2) as the main component have polystyrene skeletons, and the microscopic phase separability improves, whereby the defects based on the faulty microscopic phase separation sites can be reduced, and the fine repeated pattern can be formed. The organic solvent solution of the obtained polymer material for self-assembly is applied onto a silicon substrate or the like, and baking treatment and annealing treatment are then performed, whereby the L/S pattern with the fine microscopic domain structure formed by self-assembly (with an hp of 10 nm or less, for example) can be obtained. With this achievement, the polymer material for self-assembly according to the present invention can form the L/S pattern with an hp of 10 nm or less, which is difficult by the conventional ArF excimer laser and EUV lithography, can thereby be used suitably as an etching mask material for producing semiconductors or the like, and can be extended into various fields such as applications to photonics crystals, usage as a method for controlling the domain size of organic thin film solar cells, drug delivery polymer micelles, and biomaterials.

### EXAMPLES

The following describes examples and a comparative example performed to clarify the advantageous effects of the present invention. The following examples and comparative example do not limit the present invention at all.

### Example 1

A 5-L anionic polymerization reactor was dried under reduced pressure, and 4,500 g of a tetrahydrofuran (THF) solution subjected to distillation dehydration treatment with metallic sodium and anthracene was injected thereinto under reduced pressure and was cooled to −70° C. Next, 12.2 ml of s-butyl lithium (a cyclohexane solution: 2.03 mol/L) was injected into the cooled THF solution. Subsequently, 164.0 g of styrene subjected to distillation purification treatment was added dropwise thereto while adjusting a dropping speed so as not to make the internal temperature of the reaction solution −60° C. or higher, and after the end of the dropwise addition, the reaction solution was reacted for 30 minutes. After that, 96.6 g of 4-t-butoxy styrene subjected to distillation dehydration treatment was further added dropwise to the reaction solution, and the reaction solution was reacted for 30 minutes. Next, 164.0 g of styrene and 96.6 g of 4-t-butoxy styrene were successively added dropwise thereto to continuously perform a polymerization reaction. After that, 30 g of methanol was charged thereinto to stop the polymerization reaction. Subsequently, the reaction solution was added dropwise to 20 L of methanol, and through filtration and drying, 521.2 g of white powdery Tetrablock Copolymer (1-1) was obtained.

Next, obtained the Tetrablock Copolymer (1-1) was dissolved in 2,000 g of acetone and was charged into a 5-L reaction vessel, 5.0 g of hydrochloric acid was then added thereto, and a deprotection reaction of the t-butyl group into the hydroxy group was performed in an argon atmosphere at 40° C. for 20 hours. After that, the reaction solution was cooled to near room temperature, and the reaction solution was charged into 10 L of water to stop the reaction. Next, the obtained white powdery polymer was filtered out, washed with water, and dried in a vacuum to obtain 465.7 g of Tetrablock Copolymer (1-2).

Measurement of Composition Ratio of Tetrablock Copolymer (1-1)

The composition ratio of the obtained Tetrablock Copolymer (1-1) was measured by ¹H-NMR measurement, and the number average molecular weight Mn and the polydispersity index (PDI) were measured by the gel permeation chromatography (GPC).

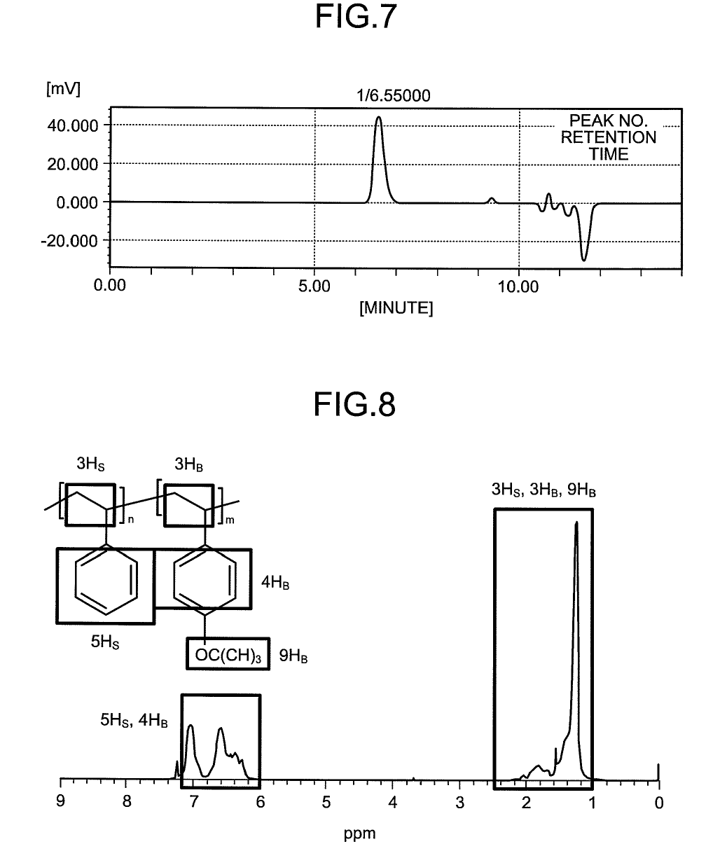

FIG. 7 is a diagram of a GPC chart of Tetrablock Copolymer (1-1). As illustrated in FIG. 7, as a result of the measurement of GPC in terms of the standard polystyrene, the Mn of the obtained Tetrablock Copolymer (1-1) was 21,000 g/mol, and the PDI thereof was 1.02.

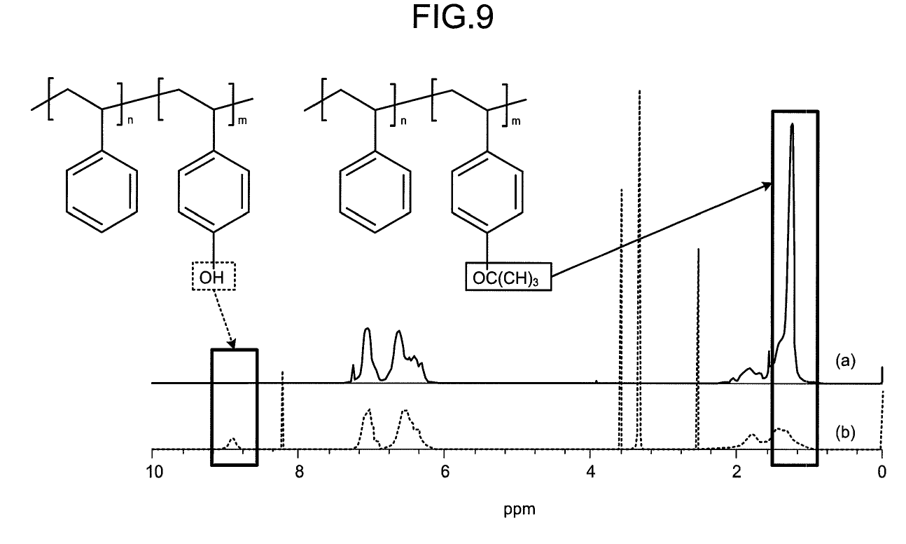

FIG. 8 is a diagram of a ¹H-NMR measurement result of Tetrablock Copolymer (1-1). FIG. 9 is a diagram of ¹H-NMR measurement results of Tetrablock Copolymer (1-1) and Tetrablock Copolymer (1-2). FIG. 9 illustrates a ¹H-NMR measurement result of the tetrablock copolymer before deprotection in (a) and illustrates a ¹H-NMR measurement result of the tetrablock copolymer after deprotection in (b). As illustrated in FIG. 8 and FIG. 9, the measurement results of ¹H-NMR revealed signals 5H_{S} and 4H_{B} (6.0 ppm to 7.0 ppm) originated from a benzene ring, signals 3H_{B}, 3H_{S}, and 9H_{B} (6.2 ppm to 7.2 ppm) originated from a methine group and a methylene group, and a signal (8.7 ppm to 9.2 ppm) originated from a hydroxy group. The area ratio of the signals revealed that the composition ratio of Tetrablock Copolymer (1-1) was styrene:4-t-butoxy styrene=50:50.

Average Number of Molecules of Tetrablock Copolymer (1-1)

Based on the composition ratio measured as described above, the average numbers of molecules of styrene and 4-t-butoxy styrene were calculated. The resulting average number of molecules of styrene was 75, and the resulting average number of molecules of 4-t-butoxy styrene was 75.

Measurement of Pattern

Observation with Transmission Electron Microscope (TEM)

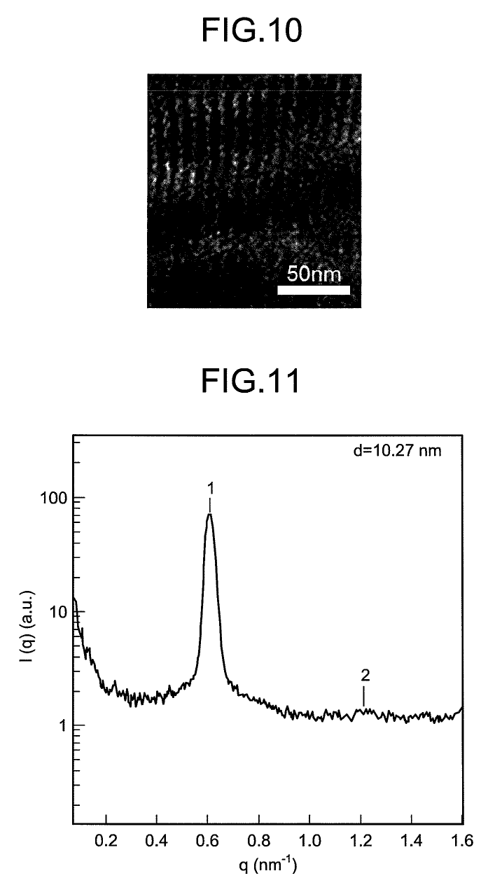

In THF, 50 mg of Tetrablock Copolymer (1-2) was dissolved, which was spread onto a Teflon petri dish, was cast for 10 days, and was dried in a vacuum. Next, the obtained film was cut into an appropriate size and was put in an embedding mold, and an epoxy resin was then poured thereinto, which was left at rest at 60° C. for 12 hours to cure the epoxy resin, whereby embedding treatment was performed. Next, a section for TEM observation with a thickness of about 50 nm was prepared using a microtome. Subsequently, the prepared section was gathered on a Cu grid, was dyed with Cs₂CO₃, and was then subjected to TEM observation. FIG. 10 is a transmission electron microscopic (TEM) image of the section. As illustrated in FIG. 10, the microscopic phase separation structure showed a lamella, in which an identity period was 10.6 nm, and the hp was 5.3 nm.

Measurement of Small-Angle X-Ray Scattering (SAXS)

The film of Tetrablock Copolymer (1-2) was cut into 5 mm×2 mm with a razor, and microscopic phase separability measurement in a bulk state was performed using a small-angle X-ray scattering (SAXS) analyzer of a synchrotron radiation beam line (product name: BL45XU, Spring-8, super photon ring-8GeV manufactured by High Energy Accelerator Research Organization). X-rays were made incident on the sample film of the block copolymer from an edge direction, and the angle dependence of scattering appearing on the smaller angle side was measured by an imaging plate for 30 minutes. Concerning measured data processing, background correction such as air scattering was performed to calculate q/nm-1, Fourier transformation analysis was performed, and the value of half pitch (hp) of the self-assembled film, which was half the average repeated pattern size width (=D) of the microscopic domain structure by the self-assembly of the block copolymer. The resulting identity period and hp were 10.8 nm and 5.4 nm, respectively.

### Example 2

A 5-L anionic polymerization reactor was dried under reduced pressure, and 4,500 g of a tetrahydrofuran (THF) solution subjected to distillation dehydration treatment with metallic sodium and benzophenone was injected thereinto under reduced pressure and was cooled to −70° C. Next, 25.5 ml of s-butyl lithium (a cyclohexane solution: 2.03 mol/L) was injected into the cooled THF solution, 63.8 g of 4-methoxy styrene subjected to distillation purification treatment was injected thereinto while adjusting a dropping speed so as not to make the internal temperature of the reaction solution −60° C. or higher, and after the end of the dropwise addition, the reaction solution was reacted for 30 minutes. Next, 162.4 g of 4-t-butoxy styrene was added dropwise and injected thereinto, and the reaction solution was reacted for 30 minutes. After that, 63.8 g of 4-methoxy styrene was again added dropwise thereto to polymerize Triblock Copolymer (1). Next, 30 g of methanol was injected thereinto to stop the reaction, and the reaction solution was then concentrated under reduced pressure. Next, 335 g of acetone was injected thereinto to redissolve Triblock Copolymer (1), which was then added to 18.5 L of ultrapure water, and Triblock Copolymer (1) was precipitated and washed. Next, the solid component was filtered out with a filter and was dried under reduced pressure at 50° C. for 20 hours to obtain 414.2 g of a white powdery solid of Triblock Copolymer (1).

Next, 280.8 g of the obtained Triblock Copolymer (1) was dissolved in 1,684.8 g of THF and was injected into a 5-L reaction vessel, 982.8 g of methanol and 5.62 g of oxalic acid were then added thereto, and a deprotection reaction was performed in a nitrogen atmosphere at 40° C. for 20 hours. Next, the reaction solution was cooled to near room temperature, and 11.2 g of pyridine was then added thereto to perform a neutralization reaction. Next, the obtained deprotection reaction solution was concentrated under reduced pressure, and 390 g of acetone and 390 g of THF were then injected thereinto to redissolve the precipitated Triblock Copolymer (2). Next, the solution of Triblock Copolymer (2) after deprotection was added to 18.5 L of ultrapure water, and Triblock Copolymer (2) was precipitated and washed. Next, the solid component was filtered out with a filter and was dried under reduced pressure at 50° C. for 20 hours to obtain 233.8 g of a white powdery solid of Triblock Copolymer (2).

Using the obtained Triblock Copolymer (2), the composition ratio, the Mn, and the PDI of Triblock Copolymer (1) were measured by the methods of measurements described above. The measurement results are shown below and are listed in the following Table 2.

Composition ratio of Triblock Copolymer (1)
4-methoxy styrene:4-t-butoxy styrene=51.2:48.8

Average number of molecules of Triblock Copolymer (1)
4-methoxy styrene: 32.2, 4-t-butoxy styrene: 30.7

Mn=8,000 g/mol

PDI=1.06

Next, the identity period and the hp of the pattern prepared by the method described above were measured. FIG. 11 is a diagram of a SAXS observation result of a pattern obtained using Triblock Copolymer (2). As illustrated in FIG. 11, the identity period (d) was 10.27 nm, and the hp was 5.4. The measurement results are listed in the following Table 2.

### Example 3

A 5-L anionic polymerization reactor was dried under reduced pressure, and 4,500 g of a tetrahydrofuran (THF) solution subjected to distillation dehydration treatment with metallic sodium and benzophenone was injected thereinto under reduced pressure and was cooled to −70° C. Next, 25.5 ml of s-butyl lithium (a cyclohexane solution: 2.03 mol/L) was injected into the cooled THF solution, 64.0 g of 2-vinyl pyridine subjected to distillation purification treatment was injected thereinto while adjusting a dropping speed so as not to make the internal temperature of the reaction solution −60° C. or higher, and after the end of the dropwise addition, the reaction solution was reacted for 30 minutes. Next, 162.0 g of 4-t-butoxy styrene was added dropwise and injected thereinto, and the reaction solution was reacted for 30 minutes. After that, 64.0 g of 2-vinyl pyridine was again added dropwise thereto, and 162.0 g of 4-t-butoxy styrene was added dropwise thereto to polymerize Tetrablock Copolymer (2-1). Next, 30 g of methanol was injected thereinto to stop the reaction, and the reaction solution was then concentrated under reduced pressure. Next, 1,397.4 g of acetone was injected thereinto to redissolve Tetrablock Copolymer (2-1), which was then added to 18.5 L of ultrapure water, and Tetrablock Copolymer (2-1) was precipitated and washed. Next, the solid component was filtered out with a filter and was dried under reduced pressure at 50° C. for 20 hours to obtain 280.8 g of a white powdery solid of Tetrablock Copolymer (2-1).

Next, 280.8 g of the obtained Tetrablock Copolymer (2-1) was dissolved in 1,684.8 g of THF and was injected into a 5-L reaction vessel, 982.8 g of methanol and 5.62 g of oxalic acid were then added thereto, and a deprotection reaction was performed in a nitrogen atmosphere at 40° C. for 20 hours. Next, the reaction solution was cooled to near room temperature, and 11.2 g of pyridine was then added thereto to perform a neutralization reaction. Next, the obtained deprotection reaction solution was concentrated under reduced pressure, and 390 g of acetone and 390 g of THF were then injected thereinto to redissolve the precipitated Tetrablock Copolymer (2-2). Next, the solution of Tetrablock Copolymer (2-2) after deprotection was added to 18.5 L of ultrapure water, and Tetrablock Copolymer (2-2) was precipitated and washed. Next, the solid component was filtered out with a filter and was dried under reduced pressure at 50° C. for 20 hours to obtain 230.2 g of a white powdery solid of Tetrablock Copolymer (2-2).

Using the obtained Tetrablock Copolymer (2-2), the composition ratio, the Mn, the PDI, and the SAXS of Tetrablock Copolymer (2-1) were measured similarly to Example 1. The measurement results are shown below and are listed in the following Table 2.

Composition ratio of Tetrablock Copolymer (2-1)
2-vinyl pyridine:4-t-butoxy styrene=49.9:50.1

Average number of molecules of Tetrablock Copolymer (2-1)
2-vinyl pyridine: 39.9, 4-t-butoxy styrene: 40.1

Mn=9,000 g/mol

PDI=1.05

Identity period (d) 8.2 nm

hp=5.1

### Comparative Example 1

A 5-L anionic polymerization reactor was dried under reduced pressure, and 4,500 g of a tetrahydrofuran (THF) solution subjected to distillation dehydration treatment with metallic sodium and benzophenone was injected thereinto under reduced pressure and was cooled to −70° C. Next, 25.5 ml of s-butyl lithium (a cyclohexane solution: 2.03 mol/L) was injected into the cooled THF solution, 108.0 g of 4-trimethylsyril styrene subjected to distillation purification treatment was added dropwise thereto while adjusting a dropping speed so as not to make the internal temperature of the reaction solution −60° C. or higher, and after the end of the dropwise addition, the reaction solution was reacted for 30 minutes. Next, 99.1 g of 4-hydroxy styrene was added dropwise and injected thereinto, and the reaction solution was reacted for 30 minutes to polymerize Diblock Copolymer (1). Next, 30 g of methanol was injected thereinto to stop the reaction, and the reaction solution was then concentrated under reduced pressure. Next, 621.3 g of acetone was injected thereinto to redissolve Diblock Copolymer (1), which was then added to 18.5 L of ultrapure water, and Diblock Copolymer (1) was precipitated and washed. Next, the solid component was filtered out with a filter and was dried under reduced pressure at 50° C. for 20 hours to obtain 207.1 g of a white powdery solid of Diblock Copolymer (1).

Next, the obtained Diblock Copolymer (1) was dissolved in 1,242.6 g of THF and was injected into a 5-L reaction vessel, 724.9 g of methanol and 4.14 g of oxalic acid were then added thereto, and a deprotection reaction was performed in a nitrogen atmosphere at 40° C. for 20 hours. Next, the reaction solution was cooled to near room temperature, and 8.3 g of pyridine was then added thereto to perform a neutralization reaction. Next, the obtained deprotection reaction solution was concentrated under reduced pressure, and 270 g of acetone and 270 g of THF were then injected thereinto to redissolve Diblock Copolymer (2). Next, the solution of Diblock Copolymer (2) after deprotection was added to 18.5 L of ultrapure water, and Diblock Copolymer (2) was precipitated and washed. Next, the solid component was filtered out with a filter and was dried under reduced pressure at 50° C. for 20 hours to obtain 157.1 g of a white powdery solid of Diblock Copolymer (2).

Using the obtained diblock copolymer (2), the composition ratio, the Mn, the PDI, and the SAXS of diblock copolymer (1) were measured similarly to Example 1. The measurement results are shown below and are listed in the following Table 2.

Composition ratio of Diblock Copolymer (1)
4-trimethylsilyl styrene:4-hydroxy styrene=57.0:43.0

Mn=4,000 g/mol

PDI=1.05

SAXS: No microscopic phase separation structure was observed.

TABLE 2

| | | Mn | | hp |
|---|---|---|---|---|
| | Composition of copolymer | (g/mol) | PDI | (nm) |
| Example | Tetrablock Copolymer (1-1) | 21,000 | 1.02 | 5.4 |
| 1 | P (St-b-tBuOSt-b-St-b-tBuoSt) | | | |
| | Composition ratio: | | | |
| | St:tBuOSt = 50:50 | | | |
| Example | Triblock Copolymer (1) | 8,000 | 1.06 | 5.4 |
| 2 | P (MeOSt-b-tBuOSt-b-MeOSt) | | | |
| | Composition ratio: | | | |
| | MeOSt:tBuOSt = 51.2:48.8 | | | |
| Example | Tetrablock Copolymer (2-1) | 9,000 | 1.05 | 5.1 |
| 3 | P (2VP-b-tBuOSt-b-2VP-b- | | | |
| | tBuOSt) | | | |
| | Composition ratio: | | | |
| | 2VP:tBuOSt = 49.9:50.1 | | | |
| Compara- | Diblock Copolymer (1) | 4,000 | 1.05 | — |
| tive | P (TMSSt-b-HSt) | | | |
| Example | Composition ratio: | | | |
| 1 | TMSSt:HSt = 57.0:43.0 | | | |

In Table 2, P represents a polymer, St represents styrene, tBuOSt represents 4-t-butoxy styrene, MeOSt represents 4-methoxy styrene, HSt represents 4-hydroxy styrene, 2VP represents 2-vinyl pyridine, TMSSt represents trimethylsilyl styrene, and ETOETOSt represents 4-ethoxyethyl styrene. The symbol -b- indicates being bonded with a block chain. The hp in Table 2 lists values measured by TEM observation after forming Tetrablock Copolymer (1-2), Triblock Copolymer (2), and Tetrablock Copolymer (2-2) by converting the t-butyl group of Tetrablock Copolymer (1-1), Triblock Copolymer (1), and Tetrablock Copolymer (2-1), respectively, into the hydroxy group by hydrolysis.

As can be seen from Table 2, the multi-block copolymer containing the first polymer block with the structural unit of the specific structure as the main component and the second polymer block with the structural unit of the specific structure as the main component that are coupled with each other can easily obtain the microscopic phase separation structure with an hp of 10 nm or less (Example 1 to Example 3). It can be seen from this result that the present invention can reduce the defects based on the faulty microscopic phase separation sites and can besides form the fine, minute repeated pattern. In contrast, it can be seen that no microscopic phase separation structure is observed both in the case of not having the structural unit of the specific structure and in the case of being the diblock copolymer even with the structural unit of the specific structure. This result is considered to be due to not being the multi-block copolymer of the triblock copolymer containing the first polymer block and the second polymer block with the structural units of the specific structures as the main components that are coupled with each other or a higher-block copolymer, whereby the block chain length was short, which did not result in the microscopic phase separation structure.

The present invention can provide a polymer material for self-assembly that can reduce defects based on faulty microscopic phase separation sites and can besides form a fine, minute repeated pattern, and can also provide the self-assembled film, a method for producing the self-assembled film, the pattern, and a method for forming the pattern.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A polymer material for self-assembly comprising a multi-block copolymer containing a first polymer block with a structural unit represented by the following General Formula (1) as a main component and a second polymer block with a structural unit represented by the following General Formula (2) as a main component that are coupled with each other: 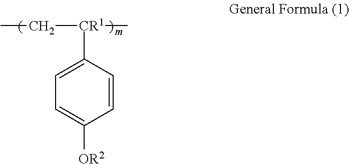
(in General Formula (1), R¹ indicates a hydrogen atom or a C₁₋₃ alkyl group, R² indicates a hydrogen atom or a C₁₋₅ alkyl group, and m is an integer of 1 or more and 1,000 or less); and 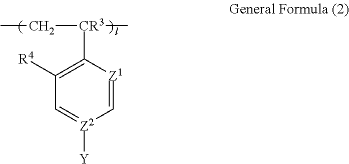
(in General Formula (2), Z¹ and Z² each represent a carbon atom or a nitrogen atom, in which when either Z¹ or Z² is a nitrogen atom, the other is a carbon atom; Y is absent when Z² is a nitrogen atom, and represents a hydrogen atom or OR⁵ when Z² is a carbon atom; R³ represents a hydrogen atom or a C₁₋₃ alkyl group; R⁴ represents a hydrogen atom, a vinyl group, or a C₂₋₅ vinylidene group; R⁵ represents a C₁₋₁₀ alkyl group; and 1 is an integer of 1 or more and 1,000 or less).

2. The polymer material for self-assembly according to claim 1, wherein the multi-block copolymer is a triblock copolymer or a tetrablock copolymer.

3. The polymer material for self-assembly according to claim 1, wherein the multi-block copolymer is copolymerized by living anionic polymerization.

4. The polymer material for self-assembly according to claim 1, wherein the multi-block copolymer has a weight −average molecular weight of 3,000 or more and 50,000 or less.

5. A self-assembled film comprising the polymer material for self-assembly according to claim 1.

6. The self-assembled film according to claim 5, wherein a top coating agent is applied onto a surface thereof.

7. A method for producing a self-assembled film, the method comprising forming a self-assembled film using the polymer material for self-assembly according to claim 1.

8. The method for producing a self-assembled film according to claim 7, wherein the self-assembled film is formed within a guide pattern.

9. The method for producing a self-assembled film according to claim 7, further comprising applying a top coating agent onto the self-assembled film.
